(19) United States
(12) Patent Application Publication
(10) Pub. No.: US 2010/0001008 A1
(43) Pub. Date: Jan. 7, 2010

(54) Insulating Glass Unit as Shipping Container

(76) Inventors: Wil McCarthy, Lakewood, CO (US); Richard M. Powers, Lakewood, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/497,365

(22) Filed: Jul. 2, 2009

Related U.S. Application Data
(60) Provisional application No. 61/078,278, filed on Jul. 3, 2008.

(51) Int. Cl. B65D 81/38; B65D 81/26; B23P 19/04

(52) U.S. Cl. 220/592.2; 206/204; 29/700

(57) ABSTRACT

An insulating glass unit (IGU) is used for storing and transporting thermoreflective filters or other thin, fragile devices, chiefly because such filters are often fragile and heavy. Because the IGU may also be the functional enclosure for the thermoreflective filter when it is installed in a building, using the IGU as a shipping container minimizes the total handling of the unpackaged filter and therefore minimizes the risk of damage or breakage.

### CROSS REFERENCE TO RELATED APPLICATIONS

This application claims the benefit of priority pursuant to 35 U.S.C. §119(e) of U.S. provisional application No. 61/078,278 filed 3 Jul. 2008 entitled “Insulating glass unit as shipping container,” which is hereby incorporated herein by reference in its entirety.

### BACKGROUND

1. Technical Field

The technology disclosed herein relates to the use of an insulating glass unit as a container for the shipping and storage of a thermoreflective filter.

2. Description of the Related Art

The energy benefits of double-paned windows have been known since Roman times, although double-paned windows did not evolve into widely used, standardized forms until the latter half of the 20th century, when the insulating glass unit, or IGU, became the most common type of window glazing, both in the United States and elsewhere in the developed world. The design, composition, assembly, packaging, storage, shipping, installation, and use of IGUs are well documented in the public domain and need no further elaboration here, except to say that the air gap between the panes of an IGU provides a dry, airtight, hermetically-sealed environment.

U.S. patent application Ser. No. 12/172,156 to Powers et al. discloses a “thermoreflective” window filter that is largely transparent when cold and largely reflective when hot, and can be used to regulate the temperatures of buildings when incorporated into windows. By the nature of their design and construction, many embodiments of this technology are large, thin, rigid, and complex in their internal structure, often including microscopic or nanoscopic optical components including, but not limited to, thin films, thin sheets, spacer beads, laminates, and highly ordered nanophotonic materials. In addition, because many of these components may be made of glass, the resulting thermoreflective filter can be both heavy and fragile, and also potentially hazardous when broken.

Switchable mirrors as described, for example, in U.S. Pat. No. 7,042,615 to Richardson are based on reversible metal hydride and metal lithide chemistry. These switchable mirrors rely on the physical migration of ions across a barrier under the influence of an electric field, and therefore have limited switching speeds and cycle lifetimes. Electrically operated “light valves” as described, for example, in U.S. Pat. No. 6,486,997 to Bruzzone, et al., combine liquid crystals with one or more reflective polarizers. In these devices, the liquid crystal typically serves as an electrotropic depolarizer, i.e., a means of rotating the polarity of the light that passes through it under the influence of an electric field. Some of these devices can be thought of as switchable mirrors, although they are rarely described that way, since their primary application is in video displays and advanced optics. Such filters, switchable mirrors, light valves, and similar devices represent a serious challenge for handling, storage, shipping, and installation.

Many types of shipping or storage containers have been used including, but not limited to, racks, shelves, boxes, cases, pallets, padded separators, and glue trays. One known type of shipping container called a glue tray or gel pack affixes thin, rigid objects such as semiconductor wafers to the bottom surface of the tray by a layer of adhesive to shield the objects from shock, vibration, abrasion, mechanical stress, or other damage. Such containers and their contents are generally insensitive to orientation or to rough handling, provided the casing itself is not dented or breached. For this reason such containers have become a standard method for shipping flat, thin, rigid objects—including objects of considerable size, for example, large semiconductor wafers, wire grid polarizers, and microscope slides. However, such gel pack- or glue tray-type enclosures do not, in addition to serving as shipping containers, also serve as the final operational housing for the item being shipped.

The information included in this Background section of the specification, including any references cited herein and any description or discussion thereof, is included for technical reference purposes only and is not to be regarded as subject matter by which the scope of the invention is to be bound.

### SUMMARY

The technology disclosed herein is directed to the use of an insulating glass unit (IGU) as a shipping and storage container for thin, flat, fragile objects, e.g., a thermoreflective filter. Because many types of thermoreflective filters are thin, heavy, fragile, rigid, or a combination thereof and thus difficult to handle, they must be packaged carefully for shipping, storage, and other handling such as during installation in the skin of a building.

In one implementation, the shipping and storage container for a thermoreflective filter switchable mirror, glass valve, or similar thin, fragile, heavy, and/or rigid device (hereafter “thin, fragile devices”) consists of two thick sheets of rigid glass, separated by an edge spacer and held together with an adhesive sealant, for example, hot-melt polyisobutyl (PIB). In other words, the shipping container is functionally identical to and capable of serving as the IGU in which the filter will ultimately be employed operationally, for example, as fenestration in a building. In one implementation, the thermoreflective filter maybe affixed to a large, flat surface of one of the glass sheets of the container by an adhesive that is both optically clear and permanent. This prevents an air gap from forming between the filter and the IGU glass, which minimizes reflection losses from the index of refraction mismatch between glass and air.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

Please note that closely related elements have the same element numbers in all figures.

FIG. 1 is from the prior art, and is a schematic, cross-section view of a typical thermoreflective filter in its cold or transmissive state.

FIG. 2 is a from the prior art, and is a schematic, cross-section view of the same thermoreflective filter in its hot or reflective state.

FIG. 3 is from the prior art, and is a schematic representation of another type of thermoreflective filter, in which the thermoreflective filter is an electrorefletive filter with one or more temperature sensors and a control system.

FIG. 4 is an exploded view of the thermoreflective filter in its shipping container.

### DETAILED DESCRIPTION OF THE INVENTION

The structure, composition, manufacture, and function of insulating class units (IGUs) are well documented. However, the idea of a shipping container made of an IGU may seem counterintuitive. Although IGUs are rarely employed as load-bearing members in a structure, they are generally robust enough to resist shattering during normal handling and operation. It is therefore common practice to construct IGUs from tempered, heat-strengthened, annealed, chemically strengthened, or laminated glass. Even in cases where ordinary float glass, plate glass, or blown glass is used to construct the IGU, the glass is often 6 mm thick or more, giving it considerable shatter resistance and compressive strength. In addition, IGUs are typically stored and shipped in racks, with little or no additional packaging to protect them. Thus, an IGU may function as an adequate shipping container for a thermoreflective filter or other thin, fragile device.

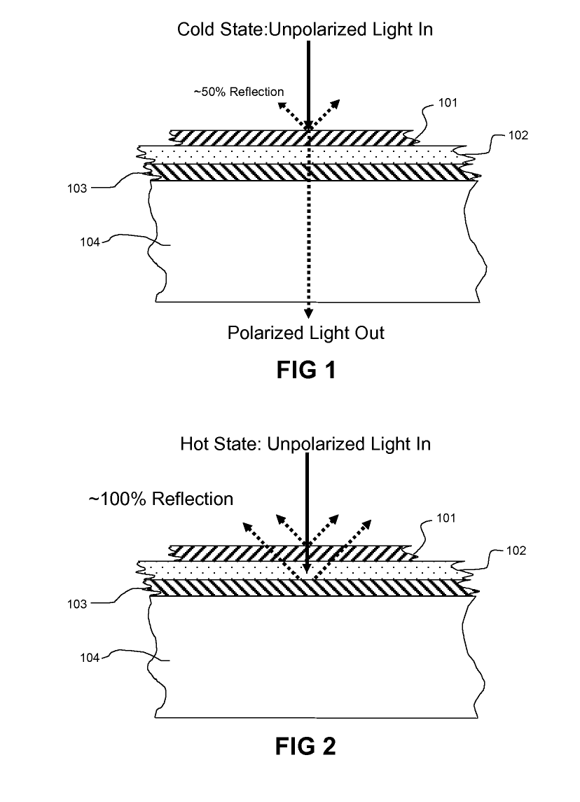

FIGS. 1 and 2 are from U.S. patent application Ser. No. 12/172,156 to Powers et al., and are schematic, cross-section views of an exemplary form of thermoreflective filter 100 which includes a depolarizer layer 102 sandwiched between two reflective polarizing filters 101 and 103, and which is attached to an optional transparent substrate 104. Incoming light first passes through the outer reflective polarizer 101. Of the incoming light, approximately 50% will have polarization perpendicular to that of the polarizer 101 and will be reflected away.

Once it has passed through the outer reflective polarizing filter 101, the incoming light enters the thermotropic depolarizer 102, which is a device or material capable of exhibiting two different polarizing states. In a hot or isotropic or liquid state, the polarized light passing through the thermotropic polarizer 102 is not affected. In a cold (e.g., nematic or crystalline) state, the thermotropic depolarizer 102 rotates the polarization vector of the incoming light by a fixed amount.

Once the light has passed through the thermotropic depolarizer 102, the remaining polarized light strikes the inner reflective polarizer 103, also known as the “analyzer,” where it is either reflected or transmitted, depending on its polarization state. The inner reflective polarizer 103 is oriented such that its polarization is perpendicular to that of the outer reflective polarizer 101. Thus, in the hot state of the thermoreflective filter 100, when the polarization vector of the light has not been rotated, the polarity of the light is perpendicular to that of the inner reflective polarizer 103, and approximately 100% of it is reflected. However, in the cold state, when the polarization vector of the light has been rotated by 90 degrees and is parallel to the inner reflective polarizer 103, a small amount of the light is absorbed by the inner reflective polarizer 103, and the rest is transmitted through.

In FIG. 1, the action of incoming light is depicted for the cold state of the thermoreflective filter 100, wherein the outer reflective polarizer 101 reflects approximately 50% of the incoming light. The remaining light passes through the thermotropic depolarizer 102 where the polarization vector of the light is rotated, and then through the inner reflective polarizer or analyzer 103 where the light is largely unaffected. It then passes through an optional transparent substrate 104, and finally exits the device 100. Thus, in its cold state the device 100 serves as a “half mirror” that reflects approximately 50% of the light striking its outer surface, absorbs a small amount, and transmits the rest through to the inner surface.

In FIG. 2, the action of incoming light is depicted for the hot state of the filter device 100. As in FIG. 1, the outer reflective polarizing filter 101 reflects approximately 50% of the morning light. However, in the hot state the thermotropic depolarizer 102 does not affect the polarization vector of the light passing through it. Thus, any light striking the inner reflective polarizer is of perpendicular polarity to it, and approximately 100% is reflected back. The filter device 100 therefore serves as a “full mirror” that reflects approximately 100% of the light striking its outer surface. Thus, in its cold state the device 100 transmits slightly less than half the light energy that strikes its outer surface, whereas in the hot state the device 100 transmits substantially less than 1 % of the light energy. As a result, the filter device 100 can be used to regulate the flow of light or radiant heat into a structure based on the temperature of the filter device 100.

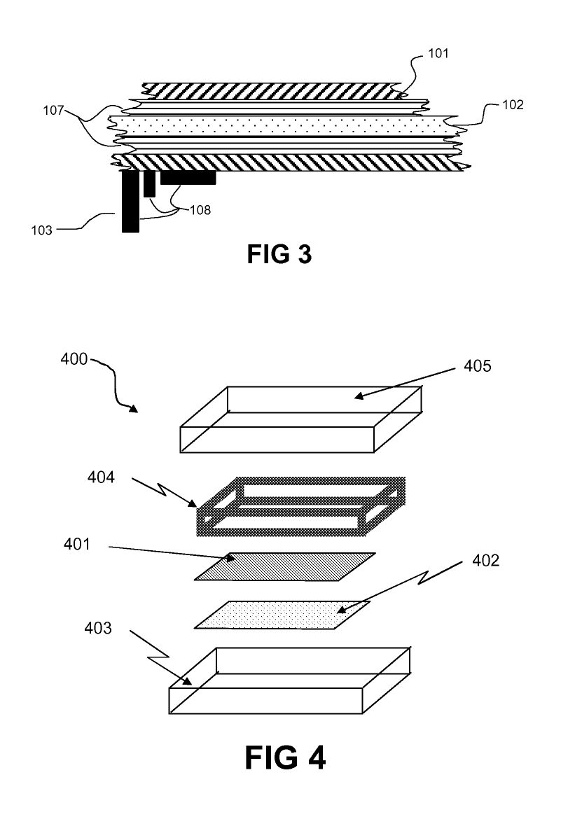

FIG. 3 is also from U.S. patent application Ser. No. 12/172,156 to Powers et al. and is a schematic representation of another type of thermoreflective filter 100′, in which the thermotropic depolarizer 102 has been replaced with an electrotropic depolarizer 102′, plus two transparent electrodes 107 and a control system 108, which collectively perform the same function as the thermotropic polarizer 102 and FIGS. 1 and 2. The operation and use of this embodiment are otherwise identical to operation and use of the embodiment shown in FIGS. 1 and 2.

FIG. 4 is an exploded view of an exemplary implementation of a shipping container 400 for a thin, fragile device 401. As contemplated herein, a thin, fragile device 401 may be rigid or flexible, heavy or light, smooth or rough, and combinations thereof depending upon the materials used to construct the thin, fragile device 401. The thin, fragile device 401, e.g., a thermochromic filter as described above, may be affixed by an adhesive layer 402 to a lower glass pane 403 within the space formed by a spacer 404. Exemplary forms of the spacer 404 for the shipping container include rectangular frames made from hollow, rectangular tubes of aluminum or stainless steel, or alternatively, polymer spacers. An upper glass pane 405 is then placed on top of the spacer 404, and the enclosure is sealed, typically with a hot-melt adhesive such as polyisobutyl (PIB). It should be understood that other sealing methods could be used as well, including methods where the seal and the spacer 404 are combined as a single object, without altering the fundamental nature of the IGU or its operation as a shipping and storage container 400.

Thus, the IGU forms a shipping container 400. The lower glass pane 403 forms the bottom of the container, the spacer 404 serves as the sidewalls, the upper glass pane 405 serves as the top, and the adhesive layer 402 secures the thin, fragile device 401 within the shipping container. In this configuration, the container 400 can be tilted, shifted, rotated, subjected to reasonable shock and vibration, or otherwise manipulated without harm to the thin, fragile device 401. Because the IGU is both sealed and composed of inert materials, the container 400 also protects the thin, fragile device 401 from dust, moisture, abrasion, chemical or particulate contamination, in a way that other container types (including but not limited to carboard boxes, wooden crates or pallets, padded separators, and wire racks) cannot.

Many optional enhancements can be made to this design without altering its fundamental nature. For example, the spacer 404 may be hollow, and filled with a dessicant material such as powered silica to remove moisture from, and prevent fogging of, the IGU interior. Alternatively, the spacer 404 may be filled with a phase-change material or high-thermal-mass material to minimize temperature fluctuations. Multiple filters or other devices may be placed side by side on the adhesive layer 402. In another embodiment, the thin, fragile device 401 may be affixed mechanically (e.g., with clips or brackets) to the IGU in addition to, or instead of, the adhesive layer 402. However, it should be understood that if an air gap exists between the thermoreflective filter 401 and the glass pane 403, there will be a reflection loss at each additional air/solid interface.

While several exemplary embodiments are depicted and described herein, it should be understood that the disclosed shipping container is not limited to these particular configurations. Optional components such as coatings, films, or fill gases may be added to suit the needs of a particular application or a particular manufacturing method, and degraded forms of some embodiments may be produced by deleting or substituting certain components. For example, the IGU glass may be replaced with a transparent polymer such as acrylic, forming an insulating polymer unit and similarly function as a shipping and storage container for a thin, fragile device. Alternatively, one or more air vents could be placed in the edge seal to allow pressures to equalize when changing altitude during transport. Furthermore, while the IGU makes a particularly useful shipping container for brittle objects, it can equally be used to ship flexible filters.

The exact arrangement of the various layers can be different than is depicted here and (depending on the materials and wavelengths selected) different layers can be combined as single layers, objects, devices, or materials, without altering the essential structure and function of the shipping container. For example, the lower pane of the IGU could serve as part of the structure of the thermoreflective filter itself, e.g., as a polarizer, transparent substrate, and/or liquid crystal alignment layer.

Thus, a shipping container for a thermoreflective filter or other thin, fragile device has been disclosed that protects the devices from various types of harm including humidity, corrosion, shock, vibration, mechanical stress, and scratching. The shipping container may also serve as the functional enclosure for the thermoreflective filter or other thin, fragile device in its end use as a building material, thus eliminating the need to create a separate shipping container in addition to the functional enclosure. The shipping container provides an adhesive layer to prevent the thermoreflective filter from moving inside the container, thus preventing damage to the filter when the container is tipped, reoriented, shaken, or otherwise disturbed. The adhesive layer provides an optically clear bond between the thermoreflective filter and the IGU glass, thus minimizing the reflection losses that would occur within an air gap. The storage and shipping container requires little or no additional packaging for safe storage and shipping. The use of an IGU as a shipping and storage container minimizes the overall handling to which the thermoreflective filter or other thin, fragile devices may be subjected between the time of its manufacture and the time of its final installation in a structure.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A shipping and storage container for a thin, fragile device comprising
a first pane of transparent or translucent material;
a second pane of transparent or translucent material;
a spacer separating the first pane from the second pane; and
a fastener for attaching a thin, fragile device to at least one of the panes such that no shifting or separation of the thin, fragile device from the shipping and storage container occurs during normal handling.

2. The shipping and storage container of claim 1, wherein the thin, fragile device comprises a thermoreflective filter.

3. The shipping and storage container of claim 1, wherein the thin, fragile device is rigid.

4. The shipping and storage container of claim 1, wherein the panes are made of glass.

5. The shipping and storage container of claim 1, wherein the panes are made of polymer.

6. The shipping and storage container of claim 1, wherein the spacer is filled with dessicant.

7. The shipping and storage container of claim 1, wherein the spacer is filled with a phase change material to limit changes in temperature.

8. The shipping and storage container of claim 1, wherein the spacer is filled with a high thermal mass material to limit changes in temperature.

9. The shipping and storage container of claim 2, wherein the fastener comprises an adhesive layer between the thermoreflective filter and at least one pane.

10. The shipping and storage container of claim 2, wherein the fastener comprises one or more clips positioned to hold the thermoreflective filter against the at least one pane.

11. The shipping and storage container of claim 2, wherein the fastener comprises one or more brackets positioned to hold the thermoreflective filter against the at least one pane.

12. A method of making a shipping and storage container for a thin, fragile device comprising
providing a first pane of transparent or translucent material;
providing a second pane of transparent or translucent material;
attaching a thin, fragile device to at least one of the panes to prevent shifting or separation of the thin, fragile device from the shipping and storage container during normal handling;
positioning the thin, fragile device between the first pane and the second pane;
inserting a spacer between the first pane and the second pane; and
sealing the first pane and the second pane to the spacer.

13. The method of claim 12 further comprising filling the spacer with dessicant.

14. The method of claim 12 further comprising filling the spacer with a phase change material to limit changes in temperature.

15. The method of claim 12 further comprising filling the spacer with a high thermal mass material to limit changes in temperature.

16. The method of claim 12, wherein the attaching operation further comprises adhering the fragile rigid device to the at least one of the panes.

17. The method of claim 12, wherein the thin, fragile device comprises a thermoreflective filter.

18. A method for shipping and storing a thin, fragile device comprising
providing disassembled components of an insulating glass unit;
attaching a thin, fragile device to a glass pane of the insulating glass unit;
assembling the insulating glass unit for shipping such that the thin, fragile device is housed within the insulating glass unit.

19. The method of claim 18, wherein the attaching operation further comprises adhering the fragile rigid device to the glass pane.

20. The method of claim 18, wherein the thin, fragile device comprises a thermoreflective filter.
